(19) United States
(12) Patent Application Publication
(10) Pub. No.: US 2017/0141474 A1
(43) Pub. Date: May 18, 2017

(54) Horn antenna and radar level gauge comprising a horn antenna

(71) Applicant: VEGA GRIESHABER KG, Wolfach (DE)

(72) Inventors: Clemens Hengstler, Haslach (DE); Juergen Skowaisa, Schiltach (DE)

(21) Appl. No.: 15/291,255

(22) Filed: Oct. 12, 2016

(30) Foreign Application Priority Data
Nov. 13, 2015 (EP) 15 194472.5

(51) Int. Cl. H01Q 13/02; H01Q 1/22; G01F 23/284; H01Q 1/12

(52) U.S. Cl. CPC H01Q 13/02; H01Q 1/125; H01Q 1/225; G01F 23/284

(57) ABSTRACT

The invention is a horn antenna for a radar measuring device, particularly a radar level gauge, with
an antenna horn emitting at the front in a primary direction of emission, showing a rear feed,
a fastening arrangement for the sealing fastening at a container,
and an at least partial filling of the antenna horn with a solid substance, with the antenna horn being embodied at least in two parts with a first part at the device side and a second part at the container side.

### CROSS REFERENCE TO RELATED APPLICATIONS

This patent application claims priority to European Patent Application 15 194472.5, filed on Nov. 13, 2015.

### STATEMENT REGARDING FEDERALLY SPONSORED RESEARCH OR DEVELOPMENT

No federal government funds were used in researching or developing this invention.

NAMES OF PARTIES TO A JOINT RESEARCH AGREEMENT

Not applicable.

### SEQUENCE LISTING INCLUDED AND INCORPORATED BY REFERENCE HEREIN

Not applicable.

### BACKGROUND

Field of the Invention

The present invention relates to a horn antenna and radar level gauge comprising a horn antenna.

Background of the Invention

Radar measuring devices are known from prior art, for example radar level gauges detecting a fill level based on the acoustical lagging principle of goods filled in a container, particularly liquids and bulk goods. Such radar level gauges are equipped with horn antennas, for example, by which a coupled HF-signal can be emitted in the direction of the filled in goods and reflected thereby. In a combined transceiver system of the radar level gauge the microwave pulses reflected by the filled in goods are detected and by measuring the traveling time of these pulses a distance is determined of the fill level gauge from the filled in goods.

Horn antennas generally show a simple and robust design, very good effectiveness, and they can be produced in a cost-effective fashion. However, as soon as the interior of the antenna horn becomes soiled, here negative consequences develop for the effectiveness of the horn antenna. Depending on the type of medium or the existing processing conditions here a vacuum or very high pressure may develop in the container, very low or very high temperatures, or the media can be very aggressive and/or corrosive. Usually it is also required that the container is sealed so that the media cannot escape to the environment.

Horn antennas are rather unsuitable due to their design when high pressures or aggressive media are involved and due to the direct access to the exciter element of the antenna they cannot be used in applications subject to the risk of explosions.

It is therefore known from prior art to protect the antennas of such fill level gauges from soiling and/or corrosion caused by an aggressive measuring environment. This is achieved for example in covering the front of the antenna with a blister or filling the antenna horn with a medium, e.g., a synthetic material.

The covering of the horn antenna with a blister can protect the antenna horn from soiling and aggressive media, however such horn antennas are still not suitable for the use in environments under pressure or subject to a vacuum.

Thus, horn antennas are known from prior art in which the antenna horn is completely filled with a solid medium, e.g., a synthetic material.

When using such a radar level gauge in hygiene-sensitive applications, e.g., in foods or the pharmaceutical industry, it is necessary to regularly clean the used containers from any soiling. In the cleaning procedures used for example in the so-called autoclaving, here steam is used at high temperatures and pressures in order to achieve sterilization of the container.

Due to the fact that the radar level gauges with horn antennas sometimes are not capable to withstand pressures, or only to a limited extent, and additionally comprise components sensitive to temperatures, the measuring devices must regularly be removed before autoclaving.

Due to the fact that the disassembly and subsequent sealing of the container is time-consuming and requires personnel, this is considered disadvantageous.

The objective of the present invention is to provide a horn antenna as well as a radar level gauge with a horn antenna which shows none of these disadvantages.

This objective is attained in a horn antenna as well as radar measuring device, each as described herein.

### BRIEF SUMMARY OF THE INVENTION

In a preferred embodiment, a horn antenna (1) for a radar measuring device, particularly a radar level gauge with

an antenna horn (3), emitting at the front in a primary direction of emission A, comprising a rear feed (5),

a fastening arrangement (7) for fastening at a container (50),

and at least a partial filling (9) of the antenna (3) with a solid substance characterized in that the antenna horn (3) is embodied in at least two parts with a first part (31) at the device side and a second part (32) at the container side.

In another preferred embodiment, horn antenna (1) as described herein, characterized in that the second part (32) is embodied as a fastening arrangement (7).

In another preferred embodiment, horn antenna (1) as described herein, characterized in that the fastening arrangement (7) is embodied as a flange, as a screw connection, or as a welded socket.

In another preferred embodiment, horn antenna (1) as described herein, characterized in that the first part (31) and the second part (32) are embodied that they can be detachably connected to each other via a connection arrangement (11).

In another preferred embodiment, horn antenna (1) as described herein, characterized in that the connection arrangement (11) is embodied as a screw connection, bayonet connection, clamped connection, plug-in connection, or as a flange.

In another preferred embodiment, horn antenna (1) as described herein, characterized in that the first part (31) comprises a circumferential edge (93) and a cap nut (14) supported at said edge (93) and the second part (32) comprises an external thread (15) embodied corresponding to the cap nut (14).

In another preferred embodiment, horn antenna (1) as described herein, characterized in that the second part (23) comprises an internal thread (16) and the first part (31) an external thread (15) embodied corresponding thereto.

In another preferred embodiment, horn antenna (1) as described herein, characterized in that the connection arrangement (11) shows a compression device.

In another preferred embodiment, horn antenna (1) as described herein, characterized in that the first part (31) and the second part (32) are embodied such that they show in the connected state a defined alignment in reference to each other.

In another preferred embodiment, horn antenna (1) as described herein, characterized in that the first part (31) comprises a first filling (91) and the second part (32) shows a second filling (92), with at least the second filling (92) being embodied such that it shows focusing features for a field emitted by the horn antenna (1).

In another preferred embodiment, horn antenna (1) as described herein, characterized in that a surface (21) of the second filling (92) facing the first part (31) is embodied convexly.

In another preferred embodiment, horn antenna (1) as described herein, characterized in that the second filling (92) is embodied conically widening in the primary direction of emission (A).

In another preferred embodiment, horn antenna (1) as described herein, characterized in that the second filling (92) shows a flange-like edge (93).

In another preferred embodiment, a radar measuring device, particularly a radar level gauge with a horn antenna (1) comprising

an antenna horn (3) emitting at the front in a primary direction of emission (A), showing a rear feed (5),

a fastening arrangement (7) for the sealing fastening at a container (50),

and an at least partial filling (9) of the antenna horn (3) with a solid substance, characterized in that the antenna horn (3) is embodied in two parts as further described herein.

### BRIEF DESCRIPTION OF THE DRAWINGS

FIG. 1 is a line drawing evidencing a first exemplary embodiment of a radar level gauge with a horn antenna according to the present application.

FIG. 2 is a line drawing evidencing a second exemplary embodiment of a radar level gauge.

FIG. 3 is a line drawing evidencing a third exemplary embodiment of a radar level gauge.

FIGS. 4a and 4b are line drawings evidencing two different embodiments of the second filling of the antenna horn.

FIGS. 5a and 5b are line drawings evidencing a fourth exemplary embodiment of the radar level gauge in a separated state.

### DETAILED DESCRIPTION OF THE INVENTION

A horn antenna according to the invention for a radar measuring device, particularly a radar level gauge, shows an antenna horn emitting at the front in a primary direction of emission with a rear feed, a fastening arrangement for fastening at a container, and at least a partially filling of the antenna horn with a solid matter, with the antenna horn being embodied from at least two parts with a first part at the device side and a second part at the container side.

By a two-part embodiment of the antenna horn the option is given that the part of the antenna horn at the device side remains connected to the container, for example during a cleaning procedure with high pressures and/or temperatures, while the first part at the device side, particularly potentially connected to a temperature sensitive measuring electronic, can be removed from the container.

For this purpose, for example seals may be arranged between the container and the second part of the antenna horn.

A beneficial embodiment can particularly be achieved when the second part is embodied as a fastening arrangement. By the embodiment of the second part of the antenna horn as a fastening arrangement it is possible with a small number of components and in a simple fashion to provide a horn antenna that can be fastened at a container, which simultaneously allows separating and thus removing for example temperature-sensitive components, for example during a cleaning process.

For this purpose, the fastening arrangement and/or the second part of the antenna horn can be embodied particularly as a flange, particularly a clamping flange or threaded flange, as a screw-connection, for example a tubular screw connection, or as a welded socket. By embodying the fastening arrangement as a flange, for example as a threaded flange or a clamping flange, the option is given to fasten the horn antenna at seats commonly provided at containers, which are typically embodied as flanges or the like.

The so-called tri-clamp connection is one of the potential embodiments.

An advantageous embodiment is achieved when the first part and the second part of the antenna horn are embodied in a detachably connected mounting arrangement. Such a mounting arrangement can be embodied for example as a screw connection, bayonet connection, clamping connection, plug-in connection, or also as a flange. In particular, connections that can be detached easily and without the use of any tools, such as bayonet connections or plug-in connections in the form of quick connects allow a particularly easy fastening and release of the connection between the two parts of the antenna horn. Here, particularly such embodiments are preferred in which the two parts are not required to be twisted counter to each other, because this way any polarization of the emitted radiation can be predetermined before the connection.

A screw-connection can be achieved for example by the first part comprising a cap nut at the circumferential edge, and supported by said edge, and the second part comprising a thread embodied corresponding to the cap nut, particularly an external thread. Such a screw-connection also allows a simple and secure connection of the two parts, with it not being required to twist the two parts counter to each other when assembling them.

The connection arrangement can further comprise a compression device, for example in the form of a pre-stressing spring, which ensures that the first part and the second part are pressed against each other with a defined pressure. This can be particularly advantageous because the reflections inside the horn antenna, particularly at a connection between the first part and the second part, shall be avoided at all costs.

In order to safely ensure a preset polarization of the emitted electromagnetic wave even after the separation and reassembly of the parts of the antenna horn it may be advantageous if the first part and the second part are embodied such that in the assembled state they show a defined alignment in reference to each other. A defined alignment in reference to each other includes particularly a defined alignment in the axial and circumferential direction. Such an alignment of the two parts in reference to each other can for example be ensured by a suitable torque-proof exterior contour of the other part and a correspondingly embodied interior contour of the second part, suitable attachments or defined stops when combining them using a screwed connection.

Advantageously the first part comprises a first filling and the second part comprises as second filling, with at least the second filling being embodied such that it shows focusing features for an electromagnetic field emitted by the horn antenna. Such focusing features can be yielded for example by a convex embodiment of a surface located in the front in a primary direction of emission, for example a conical shape or lens-shape. The second filling can here be particularly embodied such that together with the second part it seals a container towards the outside when arranged inside thereof. Here it may be particularly beneficial to optimize a material of the second filling with regards to its thermal, mechanical, and/or chemical features, particularly to provide resilience to high temperatures as well as good pressure compensation and/or mechanic stability.

A surface of the second filling facing the first part can further be embodied in a convex fashion, which considerably aggravates any accumulation or deposition of dirt and/or humidity in this area when the first part has been removed. This way it is achieved that the arrangement overall is considerably more resistant to contaminations.

If the second filling is embodied in a conically widening fashion in the primary direction of emission it is on the one hand achieved to completely fill the second part of the antenna horn and on the other hand a self-centering arrangement is generated which contacts with its entire circumferential area the second part of the antenna horn and thus shows great resistance to pressures.

The second filling can further show a flange-like edge, which particularly in a flange-like connection between the second part and the container may be clamped and for example sealed with circumferential seals. Good sealing features can be yielded in the area of such a flange-like edge and also good support of the second filling to compensate pressure-induced forces.

The second filling can for example be embodied from polyetheretherketone (PEEK), a high-strength synthetic with high mechanic, thermal, and chemical stability. This way the present horn antenna can be used in environments impinged with pressures and vacuum, comprising chemically aggressive media, and subjected to high temperature fluctuations.

Other materials suitable for the second filling may for example be ceramics, glass, polyvinylidene fluoride (PVDF), polytetrafluoroethylene (PTFE), or polyphenylene sulfide (PPS). Further possible materials are other high-performance synthetics, such as fiber-reinforced synthetics, which particularly can compensate high mechanic stress.

The first filling may be produced from a plastic with optimized HF-features, for example polytetrafluoroethylene (PTFE), polypropylene (PP), or polyethylene (PE) or other plastics with suitable high-frequency features because it is only subject to minor environmental influences.

The radar level gauge according to the invention with a horn antenna showing an antenna horn emitting at the front in a primary direction of emission and comprising a rear feed connection, a fastening arrangement for the sealing fastening at a container, and an at least partial filling of the antenna horn with a solid substance is characterized in an antenna horn embodied in two parts with a first part at the device side and a second part at the container side, with the antenna horn of the horn antenna advantageously being embodied as described above.

### DETAILED DESCRIPTION OF THE FIGURES

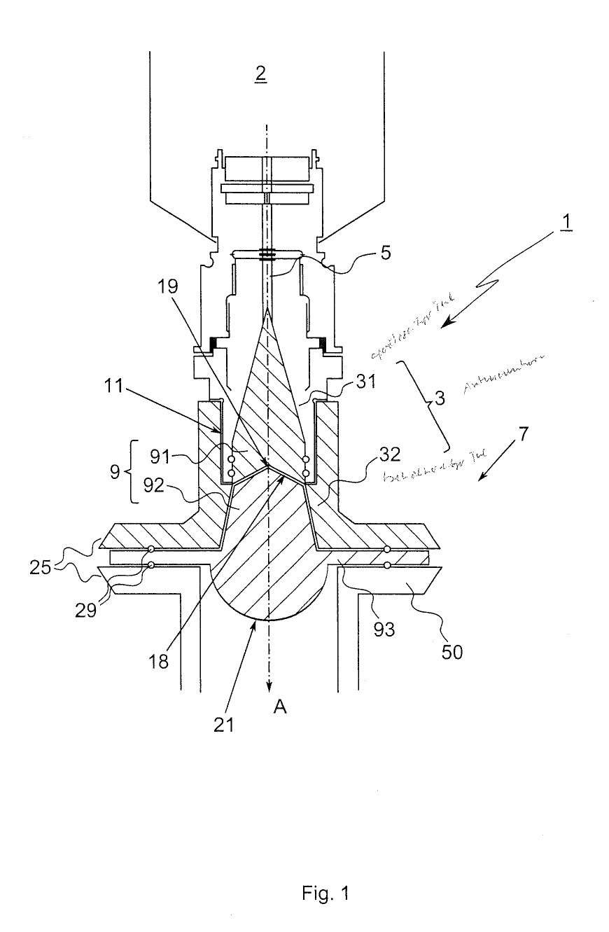

FIG. 1 shows a first exemplary embodiment of a radar level gauge with a horn antenna 1 according to the present application.

The horn antenna 1 is essentially formed as an antenna horn 3 that is essentially funnel-shaped in a primary direction of emission A, which in the present exemplary embodiment is filled with a filling 9, comprising a first filling 91 arranged at a rear side and a second filling 92 arranged at the front.

A first part 31 of the antenna horn 3 is connected at the rear to a feed 5 embodied as a hollow conductor, with the hollow conductor 5 in the present exemplary embodiment directly merging with the antenna horn 3 expanding like a funnel.

A front part 32 of the antenna horn 3 is embodied as a fastening arrangement 7, in the present case embodied as a clamping flange. By the fastening arrangement 7 it is possible to fasten the horn antenna 1 to a container 50, which shows a fastening arrangement embodied corresponding to the clamping flange. For this purpose the clamping flange and the container 50 show a suitably embodied clamping contour 25, which in the present exemplary embodiment can be fastened to each other via a clamping brace 27, not shown.

The second filling 92 arranged at the container side in the second part 32 of the antenna horn 3 is provided in the present exemplary embodiment with a convex-shaped free surface 21 similar to a spherical segment, abutted by an edge 93 formed in one piece and extending in the radial direction R, i.e. particularly perpendicular to the primary direction of emission A. The edge 93 is embodied such that it can be clamped between the fastening arrangement 7 of the fill level gauge and the clamping flange of the container 50 embodied corresponding thereto, and by an appropriately arranged seal 29 here a medium-tight closure of the container 50 is ensured. A second surface 19 of the second filling 92, which is oriented in the direction of the first part 31 of the antenna horn 3, is embodied in the present exemplary embodiment in a convex shape, particularly in a conical fashion. Any condensation precipitating on the second surface 19 or other liquids can drain off particularly easily due to this embodiment.

The first filling 91 of the first part 31 of the antenna horn 3 comprises a first surface 18 embodied corresponding to the second surface 19, which in the present exemplary embodiment is formed concavely with a funnel-shaped recess. The first filling 91 is sealed circumferentially in the first part 31 with other seals 34, so that the first part 31 is also protected from the penetration of contaminants and/or liquid media. The first part 31 and the second part 32 are connected in the present exemplary embodiment via a connection arrangement 11, which can be embodied for example as a screwed in connection.

At the rear, the horn antenna 1 comprises a feed 5, which in the present exemplary embodiment is formed as a hollow conductor feeding the antenna horn 3. The hollow conductor serves in the present exemplary embodiment as the connection of the antenna horn 3 to an arrangement generating a high-frequency signal which is arranged in an electronic 2 of the fill level gauge.

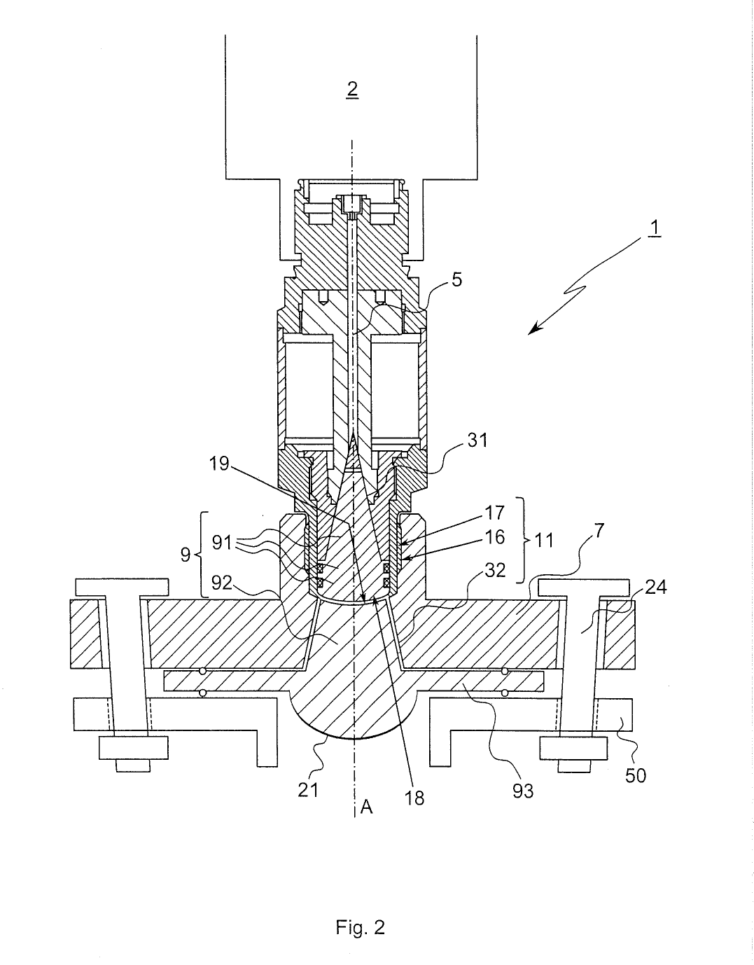

FIG. 2 shows a second exemplary embodiment of a radar level gauge with a horn antenna 1 according to the present application.

The exemplary embodiment according to FIG. 2 shows the same basic design as the exemplary embodiment according to FIG. 1. The first filling 91 shows for this purpose from the rear towards the front, i.e. starting from the hollow conductor 5 in the direction of the primary direction of emission, the following sections: a conical section, a frustum-shaped section, a cylindrical section with circumferentially arranged seals, resting in grooves, as well as a frontal end of the first filling 91 embodied as a convex first surface 18. The conical section additionally comprises a circumferential groove, in which an annular spacer, for example an O-ring serves for the centered arrangement of the first filling 91 as well as for adjusting an air gap 4.

The second filling 92 of the second part 32 is accordingly provided with a second area 19 embodied in a concave fashion. The second area 19 is embodied corresponding to the first area 18 such that a transition from the first filling 91 to the second filling 92 can occur with as little loss as possible.

The second filling 92 is otherwise essentially designed identical to the second filling 92 of the exemplary embodiment according to FIG. 1, with unlike the embodiment according to FIG. 1 the free surface 21 here not being lens-shaped but spherical. A conical embodiment of the free surface 21 allows a better drip off behavior at the free surface 21, which is particularly advantageous when thawing the free surface 21.

In the exemplary embodiment shown in FIG. 2 a connection of the horn antenna 1 to the container 50 is shown via a screwed flange at the container 50 and the fastening arrangement 7. In the bores 23, embodied corresponding and aligned to each other, screws 24 are arranged for fastening the horn antenna 1 at the container 50 and in the bores 23, arranged corresponding to each other, a screw 24 is shown for generating a screw connection of the second part 32 of the antenna horn to the container 50. This way a simple and secure fastening of the second part 32 and thus the entire horn antenna 1 is ensured.

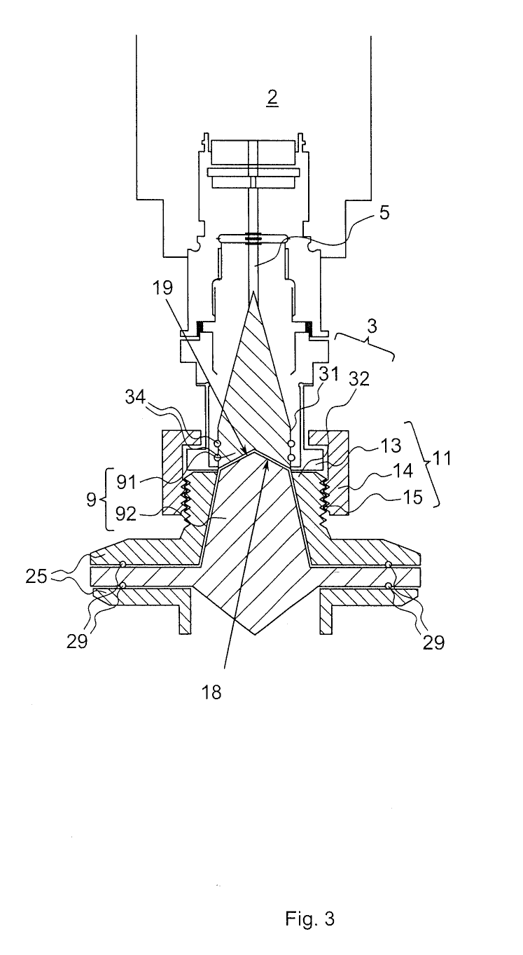

FIG. 3 shows another exemplary embodiment of a radar level gauge with a horn antenna 1 according to the present application.

The exemplary embodiment shown in FIG. 3 differs from the exemplary embodiment shown in FIG. 1 essentially in the embodiment of the connection arrangement 11, by which the first part 31 and the second part 32 of the antenna horn 3 are fastened to each other. In the exemplary embodiment shown in FIG. 3 the first part 31 of the antenna horn 3 shows a circumferential edge 13, with a cap nut 14 resting thereon. The cap nut 14 engages an external thread 14 formed at the

second part 32 such that the first part 31 and the second part 32 can be tightened to each other via the cap nut 14.

The remaining embodiment of the exemplary embodiment shown in FIG. 3 is equivalent to that of FIG. 1 and thus it is not described in greater detail to avoid repetitions.

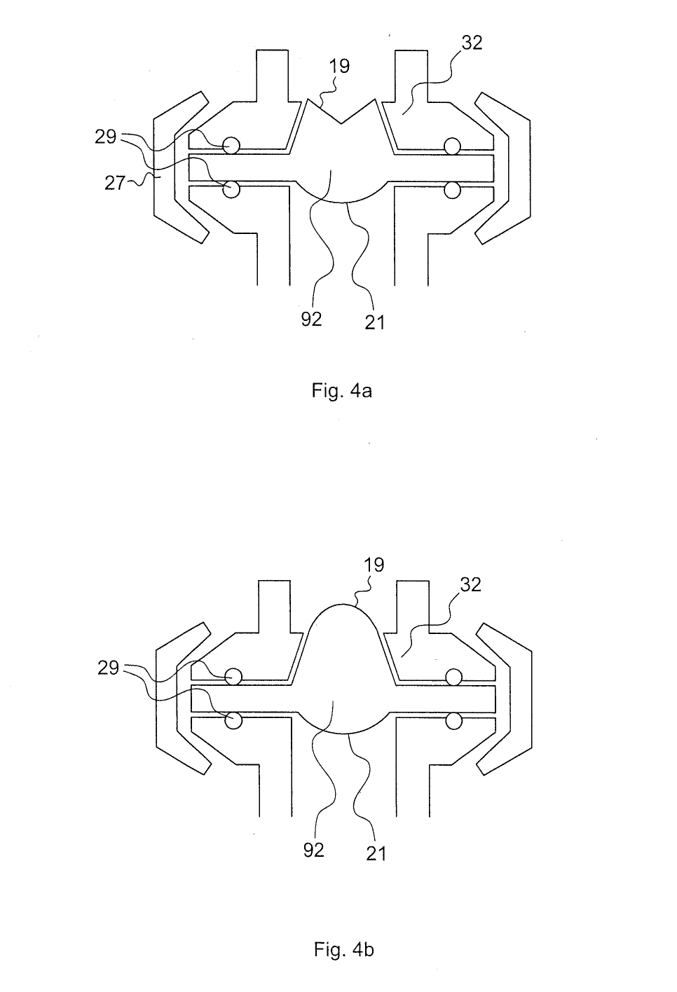

FIGS. 4a and 4b show different embodiments of the second filling 92, with in FIG. 4a a concave/convex embodiment of the second filling 92 and in FIG. 4b a convex/convex embodiment of the second filling 92 being shown.

A concave/convex embodiment represents here that the second surface 19 is concave, in the present case funnel-shaped and the free surface 21 is convex, in the present case shaped like a spherical section.

In the convex/convex embodiment shown in FIG. 4b both the second surface 19 as well as the free surface 21 are shaped convexly and in the present exemplary embodiment formed like spherical sections.

By an appropriate selection of the surface contour of the individual sections of the filling 9 as well as a suitable material selection a particularly beneficial focusing can be yielded with an optimized drip off behavior as well as an optimized transition from the first part 31 of the antenna horn 3 to the second part 32 of the antenna horn 3.

The exemplary embodiments shown in FIGS. 4a and 4b shall only illustrate as examples that a plurality of different contours is possible and covered by the scope of the present invention.

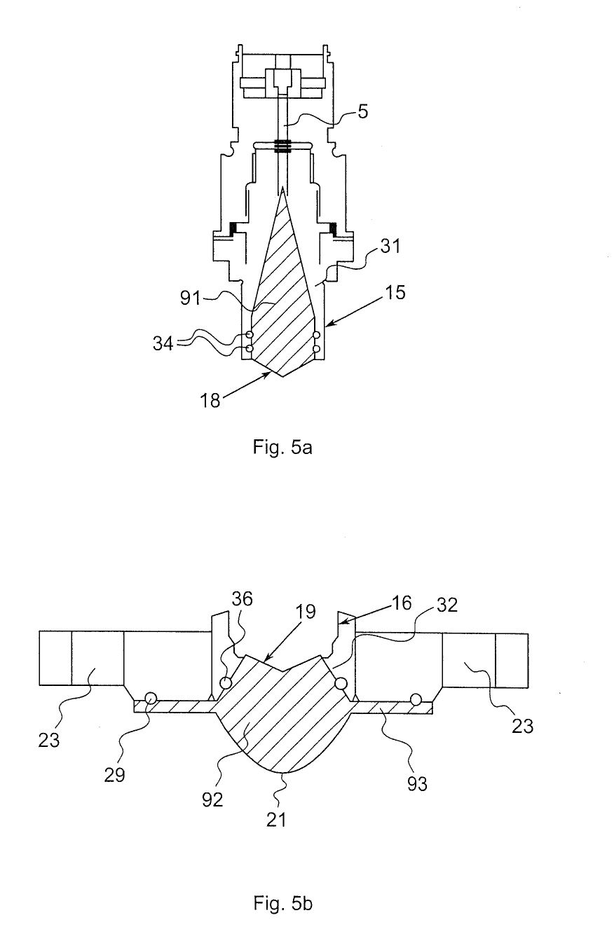

FIGS. 5a and 5b show a fourth exemplary embodiment of a radar level gauge with a horn antenna 1 according to the present application, with in FIG. 5a the first part 31 of the horn antenna 1 and in FIG. 5b the second part 32 of the horn antenna 1 being shown. The two parts 31, 32 are therefore shown in a separated state, with the connection arrangement 11 in the present exemplary embodiment being designed as an external thread 15 arranged at the first part 31 and a corresponding internal thread 16 embodied at the second part 32. The first surface 18 of the first filling 91 is embodied conically in the present exemplary embodiment, i.e. the first filling 91 shows a convex first surface 18. Corresponding thereto the second filling 92 shows a concave second surface 19, in the present case embodied funnel-shaped, which is embodied corresponding to the first surface 18. In the assembled state of the first part 31 and the second part 32 of the antenna horn 3 therefore the first surface 18 and the second surface 19 are flush abutting each other.

The second filling 92 is sealed in reference to the second part 32 via seals 29 arranged over an area of the flange-like edge 93 as well as additional seals 36 in the area of a funnel-shaped expansion of the antenna horn. A connection of the second part 32 to the container 50 occurs via a flange, which in the present case is provided with appropriate bores 23 for a screwed connection of the flange to a corresponding arrangement of the container 50.

The first filling 91 is sealed in the first part via other seals 34 so that the first part 31 of the antenna horn is protected from the penetration of contaminants. At the rear further the hollow conductor is arranged as a feed 5, which generates a connection to the electronic 2 (not shown here).

### LIST OF REFERENCE NUMBERS

1 Horn antenna
2 Electronic
3 Antenna horn
5 Feed
7 Fastening arrangement
8 Filling
11 Connection arrangement
13 Edge
14 Cap nut
15 External thread
16 Internal thread
17 External thread
18 First surface
19 Second surface
21 Free surface
23 Bore
24 Screw
25 Clamping contour
27 Clamping brace
29 Seals
31 First part
32 Second part
34 Additional seals
36 Additional seals
50 Container
91 First filling
92 Second filling
93 Edge
A Primary direction of emission
R Radial direction

The references recited herein are incorporated herein in their entirety, particularly as they relate to teaching the level of ordinary skill in this art and for any disclosure necessary for the commoner understanding of the subject matter of the claimed invention. It will be clear to a person of ordinary skill in the art that the above embodiments may be altered or that insubstantial changes may be made without departing from the scope of the invention. Accordingly, the scope of the invention is determined by the scope of the following claims and their equitable equivalents.

1. A horn antenna for a radar level gauge with
an antenna horn, emitting at the front in a primary direction of emission, comprising a rear feed,
a fastening arrangement for fastening at a container,
and at least a partial filling of the antenna with a solid substance, wherein the antenna horn is embodied in at least two parts with a first part at the device side and a second part at the container side.

2. The horn antenna according to claim 1, wherein the second part is embodied as a fastening arrangement.

3. The horn antenna according to claim 1, thatwherein the fastening arrangement (7) is embodied as a flange, as a screw connection, or as a welded socket.

4. The horn antenna according to claim 1, wherein the first part and the second part are embodied that they can be detachably connected to each other via a connection arrangement.

5. The horn antenna according to claim 4, wherein the connection arrangement is embodied as a screw connection, bayonet connection, clamped connection, plug-in connection, or as a flange.

6. The horn antenna according to claim 4, wherein the first part comprises a circumferential edge and a cap nut supported at said edge and the second part comprises an external thread embodied corresponding to the cap nut.

7. The horn antenna according to one of claim 4, wherein the second part comprises an internal thread and the first part an external thread embodied corresponding thereto.

8. The horn antenna according to claim 4, wherein the connection arrangement shows a compression device.

9. The horn antenna according to claim 1, wherein the first part and the second part are embodied such that they show in the connected state a defined alignment in reference to each other.

10. The horn antenna according to claim 1, wherein the first part comprises a first filling and the second part shows a second filling, with at least the second filling being embodied such that it shows focusing features for a field emitted by the horn antenna.

11. The horn antenna according to claim 10, wherein a surface of the second filling facing the first part is embodied convexly.

12. The horn antenna according to one of claim 10, wherein the second filling is embodied conically widening in the primary direction of emission.

13. The horn antenna according to claim 10, wherein the second filling shows a flange-like edge.

14. A radar level gauge with a horn antenna comprising
an antenna horn emitting at the front in a primary direction of emission, showing a rear feed,
a fastening arrangement for the sealing fastening at a container,
and an at least partial filling of the antenna horn with a solid substance,
wherein the antenna horn is embodied in two parts according to claim 1.
